(19) United States
(12) Patent Application Publication
(10) Pub. No.: US 2009/0249003 A1
(43) Pub. Date: Oct. 1, 2009

(54) METHOD AND SYSTEM FOR MULTIPLEXING CONCATENATED STORAGE DISK ARRAYS TO FORM A RULES-BASED ARRAY OF DISKS

(76) Inventors: ALLEN KEITH BATES, Tucson, AZ (US); NILS HAUSTEIN, Soergenloch (DE); CRAIG A. KLEIN, Tucson, AZ (US); ULF TROPPENS, Mainz (DE); STEPHEN L. SCHWARTZ, Tucson, AZ (US); DANIEL J. WINARSKI, Tucson, AZ (US); RAINER WOLAFKA, Bad Soden (DE)

Correspondence Address: INTERNATIONAL BUSINESS MACHINES CORPORATION, 9000 SOUTH RITA ROAD, TUCSON, AZ, 85744, US

(21) Appl. No.: 12/055,475

(22) Filed: Mar. 26, 2008

(51) Int. Cl. G06F 12/00

(52) U.S. Cl. 711/162; 711/E12.001

(57) ABSTRACT

A method, system and computer-readable medium are disclosed for efficiently multiplexing concatenated storage devices. An intelligent storage controller continuously monitors data access of a number of concatenated storage devices. In response to a request to write new data, the controller writes a primary data copy to the concatenated storage device having the lowest data access. Then the controller writes a secondary data copy to the device having the next lowest data access. In response to a read request, the controller reads data from the data copy located on the concatenated storage device having the lower data access. In response to an update request, the controller, after determining that data access does not exceed a predetermined threshold, the controller updates the data copy having the lowest data access, set that copy as the new primary copy and subsequently updates the other copy, setting that copy as the new secondary copy.

### BACKGROUND OF THE INVENTION

1. Technical Field

The present invention relates in general to the field of computers and computer systems, and in particular to mass storage devices used with such systems.

2. Description of the Related Art

Mass storage devices are used by modern computer systems to persistently store large volumes of data for future use. Mass storage devices are significantly less expensive per unit of stored data than other forms of computer memory, such as random access memory (RAM). A typical example of a mass storage device is a hard disk drive. A hard disk drive is comprised of a number of rigid disks known as platters which store data in a non-volatile magnetic medium coated on the platters. The drive reads from and writes data to the platters in response to input/output (I/O) requests from a central processing unit (CPU). Solid state drives comprised entirely of solid state memory, such as flash memory, could be used interchangeably with the aforementioned hard disk drives.

To provide greater storage capacity than is available in a single mass storage device, multiple mass storage devices can be concatenated into a concatenated storage device. A concatenated storage device is a popular method for combining multiple physical disk drives into a single virtual disk. A concatenated storage device provides no data redundancy. As the name implies, disks are merely concatenated together, end to beginning, so they appear to be a single large disk. This manner of concatenating storage disks is also known in the art as JBOD, or “Just a Bunch Of Disks”. In JBOD configuration, a disk controller concatenates the storage spaces of multiple physical disk drives with each other to present a single logical volume to the computer system. The single logical volume has the data storage capacity of the combination of the individual physical drives that comprise the JBOD array.

Combining multiple physical disk drives into one logical drive, however, increases the probability of data error. One drawback of storage devices in a JBOD configuration is that JBOD does not provide data redundancy. If a read or write fails, the data can be lost. RAID systems were developed, in part, to provide data redundancy and protect against errors due to disk failures. RAID is well-known in the art and is known as “Redundant Array of Inexpensive Disks” or Redundant Array of Independent Drives”. However, RAID combines physical hard disk drives into a single logical volume by using specialized hardware or software, and is more expensive than a JBOD implementation.

### BRIEF SUMMARY OF THE INVENTION

The present invention provides a method, system and computer program product for efficiently multiplexing a plurality of concatenated storage devices. The method includes continuously monitoring data access of a number of concatenated storage devices by one or more host data processing systems; receiving an input/output request from one of the host data processing systems for data access to the concatenated storage devices; determining whether the input/output request is a request to write new data, a request read stored data or a request to update stored data. In response to determining that the input/output request is a request to write new data, the method includes writing a primary data copy to a concatenated storage device, wherein said first concatenated storage device has the lowest utilization of the concatenated storage devices; writing a secondary data copy to a second concatenated storage device, wherein the second concatenated storage device has the lowest utilization of the concatenated storage devices excluding the first concatenated storage device. In response to determining that the input/output request is a request to read stored data, the method includes determining which of either the primary data copy or the secondary data copy is stored in a concatenated storage device having a lower data access than the other concatenated storage device at the time of the read request. In response to determining that the primary data copy is stored in the concatenated storage device having the lower data access at the time of the read request, the method includes reading the primary data copy. In response to determining that the secondary data copy is stored in the concatenated storage device having the lower data access at the time of the read request, the method includes reading the secondary data copy. In response to determining that the input/output request is a request to update stored data, the method includes determining whether either the primary data copy or the secondary data copy is stored in a concatenated storage device having a current data access that exceeds a predetermined threshold. In response to determining that either the primary data copy or the secondary data copy is stored in a concatenated storage device having a current data access that exceeds a predetermined threshold, the method includes writing a new primary data copy to a first concatenated storage device, wherein the first concatenated storage device has the lowest utilization of the concatenated storage devices; writing a new secondary data copy to a second concatenated storage device, wherein the second concatenated storage device has the lowest utilization of the concatenated storage devices excluding the first concatenated storage device. In response to determining that neither the primary data copy nor the secondary data copy is stored in a concatenated storage device having a current data access that exceeds a predetermined threshold, the method includes determining which of either the primary data copy or the secondary data copy is stored in a concatenated storage device having a lower data access at the time of the update request. In response to determining that the primary copy is stored in the concatenated storage device having the lower data access at the time of the read request, the method includes updating the primary data copy then subsequently updating the secondary data copy. In response to determining that the secondary data copy is stored in the concatenated storage device having the lower data access at the time of the read request, the method includes updating the secondary data copy; setting the secondary data copy as the new primary data copy; setting the primary data copy as the new secondary data copy; and subsequently updating the new secondary data copy.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a block diagram of an exemplary storage area network suited for efficiently multiplexing concatenated storage devices in accordance with one or more embodiments of the present invention;

FIG. 2 is a flowchart 200 depicting an exemplary method for efficiently multiplexing concatenated storage devices in accordance with one or more embodiments of the present invention;

FIG. 3 is a flowchart 300 that continues from flowchart 200 of FIG. 2; and

FIG. 4 is a block diagram of an exemplary data processing system suited for use with the present invention.

### DETAILED DESCRIPTION OF THE INVENTION

An illustrative embodiment of the present invention is directed to a method, system and computer program product for multiplexing concatenated storage disk arrays to form a rules-based array of disks. The present invention can take the form of an entirely hardware embodiment, an entirely software embodiment or an embodiment containing both hardware and software elements. Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, optical tape, a removable computer diskette, a random access memory (RAM), a read-only memory (ROM), a rigid magnetic disk (e.g., a hard drive), and an optical disk. Current examples of optical disks include compact disk-read only memory (CD-ROM), compact disk-read/write (CD-R/W), Digital Versatile Disk (DVD), Blu-Ray Disk (BD), and Holographic disks.

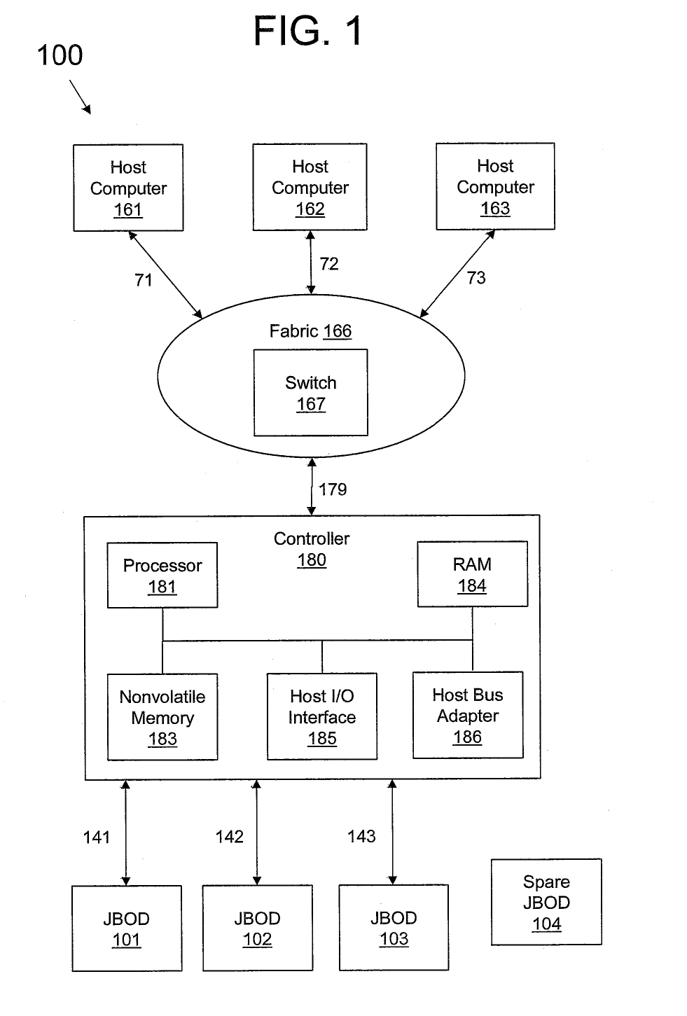

Referring now to the drawings, wherein like numbers denote like parts throughout the several views, FIG. 1 shows a block diagram of exemplary storage area network (SAN) 100 suited for efficiently multiplexing concatenated storage devices (referred to hereafter as JBODs) in accordance with one or more embodiments of the present invention. SAN 100 comprises multiple host computers 161-163. Host computers 161-163 are connected to switched fabric 166 via bidirectional links 71-73. Switched fabric 166 may comprise one or more switches 167. Switched fabric 166 communicates with intelligent storage controller 180 via link 179 and Host I/O interface 185.

Intelligent storage controller 180 communicates with JBODs 101, 102, 103 across links 141, 142, 143, respectively, via Host Bus Adapter (HBA) 186. JBODs 101-103 can be in the same locality, or geographically distributed. For example, JBODs 101-103 can be geographically distributed worldwide for disaster recovery. One or more spare JBODs 104 may also be provided. Intelligent storage controller 180 comprises processor 181, which calculates the utilizations of JBODs 101-103. The calculated utilizations may be stored in random access memory (RAM) 184 or nonvolatile memory 183.

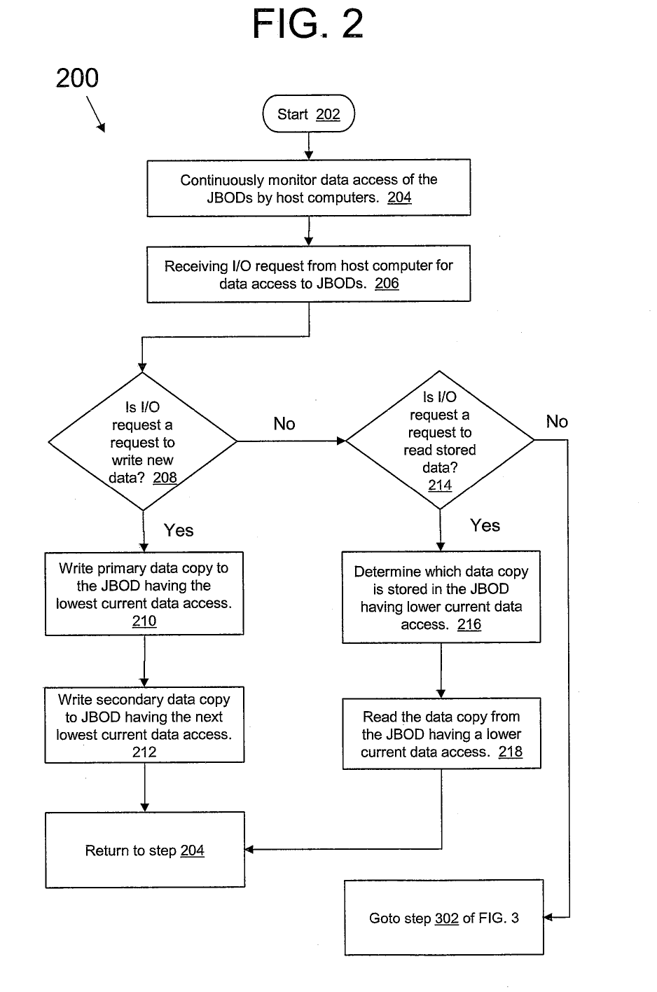

With reference now to FIG. 2, flowchart 200 is shown depicting an exemplary method for efficiently multiplexing concatenated storage devices in accordance with one or more embodiments of the present invention. The process begins at initiator block 202. Intelligent storage controller 180 continuously monitors the data access of the JBODs 101-103 by host computers 161-163 (step 204). By continuously monitoring the data access of JBODs 101-103, which is the amount of data being accessed at a particular time, intelligent storage controller 180 is able to determine the expected latency of reading from or writing data to a JBOD. For example, if JBOD 101 has the lowest current data access of JBODs 101-103, then JBOD 101 expected to have the lowest latency during a read or write operation. It is preferable to access data associated with the JBOD having the lowest latency so that the data can be transferred a quickly as possible. When intelligent storage controller 180 receives an input/output (I/O) request from any of host computers 161-163 for data access to JBODs 101-103 (step 206), intelligent storage controller 180 determines whether the I/O request is a request to write new data to JBODs 101-103 (step 208). If the I/O request is a request to write new data, then intelligent storage controller 180 writes a primary data copy to the JBOD having the lowest current data access of JBODs 101-103 (e.g., JBOD 101) at the time of the I/O request (step 210). Subsequent to writing the primary data copy, intelligent storage controller 180 writes a secondary data copy to the JBOD having the lowest current data access of the remaining JBODs 102-103 (step 212).

By writing a primary and secondary copy of data to separate JBODs, intelligent storage controller 180 enables redundant copies of data to be stored for error protection without the need to implement a more expensive RAID system. If one of JBODs 101-103 begins to experience an error rate that exceeds a predetermined threshold (for example, JBOD 103), then data can be moved from JBOD 103 to another JBOD (for example, spare JBOD 104). By writing the primary data copy to the JBOD having the lowest current data access (and subsequently the secondary data copy to the JBOD having the next lowest current data access), intelligent storage controller 180 efficiently multiplexes the data between the two JBODs having the lowest instantaneous latency. After writing the secondary data copy, the process returns to step 204, where intelligent storage controller 180 continuously monitors data access of JBODs 101-103.

Returning to step 208, if the I/O request is not a request to write new data, intelligent storage controller 180 determines whether the I/O request is a request to read stored data from JBODs 101-103 (step 214). If the I/O request is a request to read stored data, intelligent storage controller 180 determines which data copy (the primary data copy or the secondary data copy) is stored on the JBOD having lower current data access (step 216). Intelligent storage controller 180 reads the data copy from the JBOD having the lower current data access (step 218). For example, assume the primary data copy is stored in JBOD 101 and the secondary data copy is stored in JBOD 102. If intelligent storage controller 180 determines that JBOD 102 has a lower current data access than JBOD 101, then intelligent storage controller 180 will read the secondary data copy instead of the primary data copy in response to the host computer's I/O request. The process then returns to step 204, where intelligent storage controller 180 continuously monitors data access of JBODs 101-103.

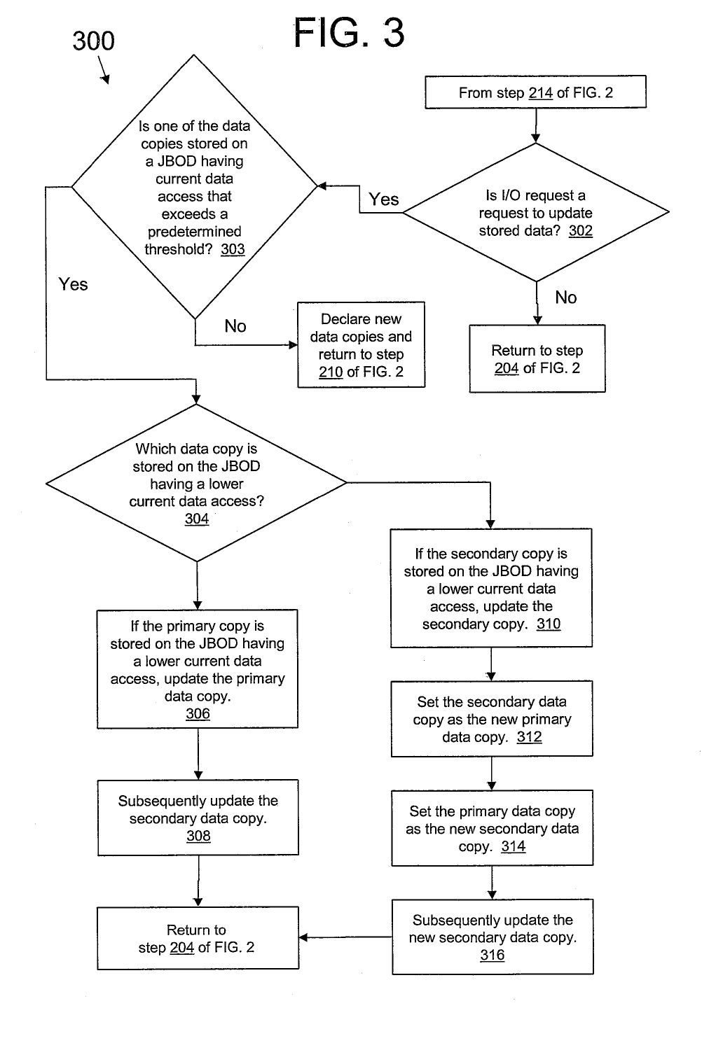

Returning to step 214, if the I/O request is not a request to read stored data, then the process proceeds to step 302 of FIG. 3, where flowchart 300 is a continuation of flowchart 200. At step 302, intelligent storage controller 180 determines whether the I/O request is a request to update stored data from JBODs 101-103. If the I/O request is not a request to update stored data, then the process returns to step 204 of FIG. 2. If the I/O request is a request to update stored data, then intelligent storage controller 180 determines whether one of the data copies is stored on a JBOD having a current data access that exceeds a predetermined threshold for data access (step 303). If either the primary data copy or secondary data copy is stored on a JBOD having a current data access that exceeds a predetermined threshold for data access, then intelligent storage controller 180 declares a new primary data copy and a new secondary data copy and the process returns to step 210 of FIG. 2 to write new a new primary data copy and a new secondary data copy to JBODs that are not as heavily accessed. Intelligent storage controller 180 moves the old primary data copy and old secondary copy to the new primary data copy and new secondary data copy at a time when the data access for the JBODs storing each copy has fallen below the predetermined threshold.

Returning to step 303, if neither data copy is stored on a JBOD having a current data access that exceeds a predetermined threshold for data access, then intelligent storage controller 180 determines which data copy is stored on the JBOD having lower current data access (step 304). If the primary data copy is stored on the JBOD having lower current data access, then intelligent storage controller 180 updates the primary data copy (step 306). Subsequent to updating the primary data copy, intelligent storage controller 180 updates the secondary data copy (step 308) and the process returns to step 204 of FIG. 2.

Returning to step 304, if the secondary data copy is stored on the JBOD having lower current data access, then intelligent storage controller 180 updates the secondary data copy (step 310) and sets the secondary data copy as the new primary data copy (step 312). Subsequent to updating the secondary data copy, intelligent storage controller 180 sets the primary data copy as the new secondary data copy (step 314) and updates the new secondary data copy (step 316). The process then returns to step 204 of FIG. 2.

The efficient multiplexing of JBODs as disclosed herein also enables a data processing system to utilize less power than conventional JBODs implementations. For example, only a subset of JBODs needs to be powered on at any time, while the other JBODs remain powered off, thus saving valuable power for both powering the JBODS and for cooling the JBODs. Whenever one JBOD gets full, intelligent controller 180 powers on another JBOD. Saving power in this manner is particularly useful for archiving applications. Archiving data can be written sequentially since archiving data does not change and expires only after a long time. Once a JBOD has been fully written, then the JBOD is not written to again and can be powered off after data is read (e.g. based on idle time policies). Archiving data is ready infrequently after it has been archived for a while, so there exists significant power saving opportunities. Retention periods can be associated with individual JBODs, wherein one JBOD keeps all data written to it for a certain time period (e.g., 10 years) while another JBOD keeps the data for a different time period (e.g. 5 years).

Another way to save power with the efficient multiplexing of JBODs as disclosed herein is to potentially power off JBODs that are full when the full JBODs have not been access for a predetermined length of time. Full JBODs can be treated as read-only disks that are powered off when no access occurs during the predetermined length of time. When a certain percentage of data on a full (read-only) disk has been deleted or updated where the updates have been written to other JBODs, the all the data is moved from that JBOD and it is powered off. Also, if work cannot be shifted to under-utilized JBODs, the under-utilized JBODs may be powered off, especially during periods of electrical brown-outs or black-outs.

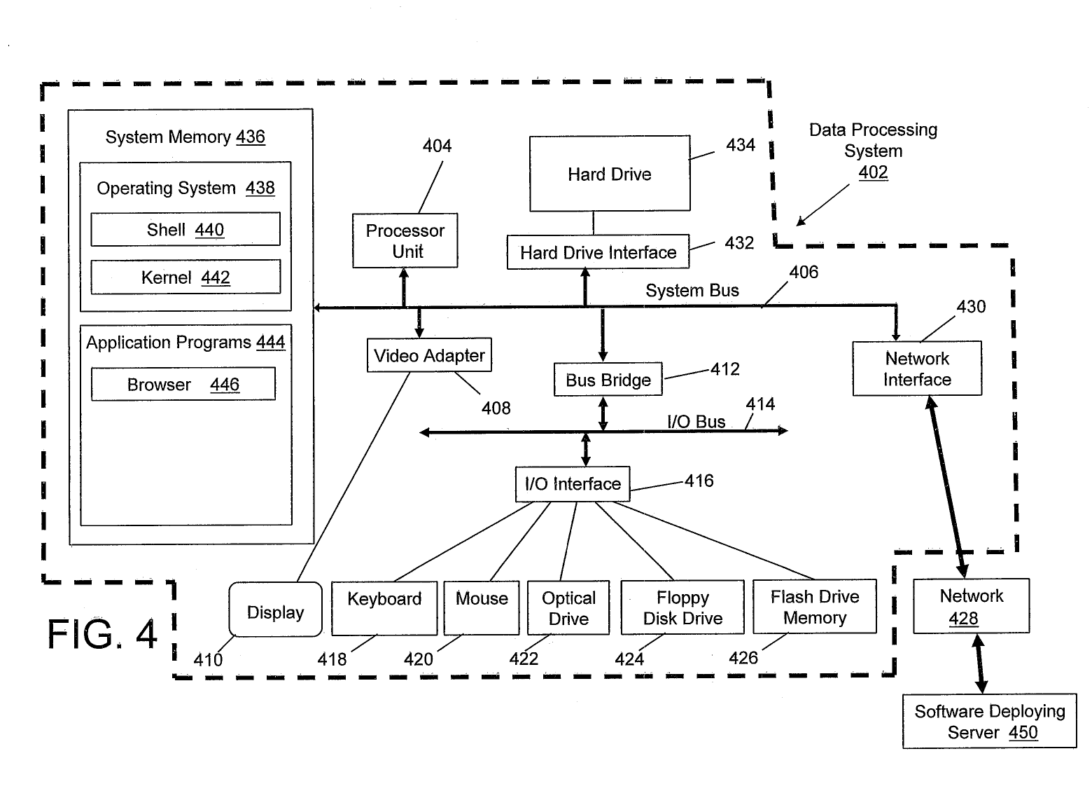

With reference now to FIG. 4, a block diagram is shown depicting a data processing system suitable for use with one or more embodiments of the present invention. The hardware elements depicted in data processing system 402 are not intended to be exhaustive, but rather are representative of one embodiment of the present invention. Data processing system 402 includes a processor unit 404 that is coupled to a system bus 406. A video adapter 408, which drives/supports a display 410, is also coupled to system bus 406. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, an optical disk drive 422, a floppy disk drive 424, and a flash drive memory 426. The format of the ports connected to I/O interface 416 may be any known to those skilled in the art of computer architecture, including but not limited to Universal Serial Bus (USB) ports.

Data processing system 402 is able to communicate with a software deploying server 450 via a network 428 using a network interface 430, which is coupled to system bus 406. Network 428 may be an external network such as the Internet, or an internal network such as an Ethernet or a Virtual Private Network (VPN). Software deploying server 450 may utilize a similar architecture design as that described for data processing system 402.

A hard drive interface 432 is also coupled to system bus 406. Hard drive interface 432 interfaces with hard drive 434. In an illustrative embodiment, hard drive 434 populates a system memory 436, which is also coupled to system bus 406. Data that populates system memory 436 includes an operating system (OS) 438 of data processing system 402 and application programs 444 (e.g., browser 446).

OS 438 includes a shell 440, for providing transparent user access to resources such as application programs 144. Generally, shell 440 is a program that provides an interpreter and an interface between the user and the operating system. More specifically, shell 440 executes commands that are entered into a command line user interface or from a file. Thus, shell 440 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 442) for processing. Note that while shell 440 is a text-based, line-oriented user interface, the present invention will equally well support other user interface modes, such as graphical, voice, gestural, etc.

As depicted, OS 438 also includes kernel 442, which includes lower levels of functionality for OS 438, including providing essential services required by other parts of OS 438 and application programs 444, including memory management, process and task management, disk management, and mouse and keyboard management.

Application programs 444 include a browser 446. Browser 446 includes program modules and instructions enabling a World Wide Web (WWW) client (i.e., data processing system 402) to send and receive network messages to the Internet using HyperText Transfer Protocol (HTTP) messaging, thus enabling communication with software deploying server 450.

The hardware elements depicted in data processing system 402 are not intended to be exhaustive, but rather are representative to highlight essential components required by the present invention. For instance, data processing system 402 may include alternate memory storage devices such as magnetic cassettes, Digital Versatile Disks (DVDs), Bernoulli cartridges, and the like. These and other variations are intended to be within the spirit and scope of the present invention.

Note further that, in one embodiment of the present invention, software deploying server 450 performs all of the functions associated with any one of application programs 444, thus freeing data processing system 402 from having to use its own internal computing resources to execute the application program(s) 444.

While the present invention has been particularly shown and described with reference to an illustrative embodiment, it will be understood by those skilled in the art that various changes in form and detail may be made therein without departing from the spirit and scope of the invention. Furthermore, as used in the specification and the appended claims, the term “computer” or “computer system” or “computing device” includes any data processing system including, but not limited to, personal computers, servers, workstations, network computers, mainframe computers, routers, switches, Personal Digital Assistants (PDA's), telephones, and any other system capable of processing, transmitting, receiving, capturing and/or storing data. The term “system” or “information system” includes a network of data processing systems.

The flowchart and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A method for efficiently multiplexing a plurality of concatenated storage devices comprising:
continuously monitoring data access of a plurality of concatenated storage devices by one or more host data processing systems;
receiving an input/output request from one of the host data processing systems for data access to the plurality of concatenated storage devices;
determining whether the input/output request is a request to write new data, a request read stored data or a request to update stored data;
in response to determining that the input/output request is a request to write new data:
writing a primary data copy to a first concatenated storage device, wherein said first concatenated storage device has the lowest utilization of the plurality of concatenated storage devices;
writing a secondary data copy to a second concatenated storage device, wherein said second concatenated storage device has the lowest utilization of the plurality of concatenated storage devices excluding the first concatenated storage device;
in response to determining that the input/output request is a request to read stored data:
determining which of either the primary data copy or the secondary data copy is stored in a concatenated storage device having a lower data access than the other concatenated storage device at the time of the read request;
in response to determining that the primary data copy is stored in the concatenated storage device having the lower data access at the time of the read request, reading the primary data copy;
in response to determining that the secondary data copy is stored in the concatenated storage device having the lower data access at the time of the read request, reading the secondary data copy;
in response to determining that the input/output request is a request to update stored data:
determining whether either the primary data copy or the secondary data copy is stored in a concatenated storage device having a current data access that exceeds a predetermined threshold;
in response to determining that either the primary data copy or the secondary data copy is stored in a concatenated storage device having a current data access that exceeds a predetermined threshold:
writing a new primary data copy to a first concatenated storage device, wherein said first concatenated storage device has the lowest utilization of the plurality of concatenated storage devices;
writing a new secondary data copy to a second concatenated storage device, wherein said second concatenated storage device has the lowest utilization of the plurality of concatenated storage devices excluding the first concatenated storage device;
in response to determining that neither the primary data copy nor the secondary data copy is stored in a concatenated storage device having a current data access that exceeds a predetermined threshold:
determining which of either the primary data copy or the secondary data copy is stored in a concatenated storage device having a lower data access at the time of the update request;
in response to determining that the primary copy is stored in the concatenated storage device having the lower data access at the time of the read request, updating the primary data copy then subsequently updating the secondary data copy;
in response to determining that the secondary data copy is stored in the concatenated storage device having the lower data access at the time of the read request:
updating the secondary data copy;
setting the secondary data copy as the new primary data copy;
setting the primary data copy as the new secondary data copy; and
subsequently updating the new secondary data copy.

2. The method of claim 1, further comprising:
continuously monitoring an error rate for each of the plurality of concatenated storage devices; and
in response to the error rate of one of the plurality of concatenated storage device exceeds a predetermined threshold, moving data from the concatenated storage device having the error rate that exceeds the predetermined threshold to a concatenated storage device that does not have an error rate that exceeds the predetermined threshold.

3. The method of claim 1, further comprising:
continuously monitoring a storage capacity of each of a plurality of concatenated storage devices;
determining whether one of the plurality of concatenated storage devices has reached a maximum storage capacity; and
in response to determining that one of the plurality of concatenated storage devices has reached a maximum storage capacity, selectively reducing the power consumption of the concatenated storage device that has reached the maximum storage capacity.

4. The method of claim 1, further comprising:
determining whether one of the plurality of concatenated storage devices has exceeded a predetermined threshold of time since the most recent input/output request; and
in response to determining that one of the plurality of concatenated storage devices has exceeded a predetermined threshold of time since the most recent input/output request, selectively reducing the power consumption of the concatenated storage device that has exceeded a predetermined threshold of time since the most recent input/output request.

5. A system for efficiently multiplexing a plurality of concatenated storage devices comprising:
one or more host computers;
a plurality of concatenated storage devices,
an intelligent storage controller coupled to said one or more host computers and said plurality of concatenated storage devices;
wherein data is directed between said plurality of concatenated storage devices and said one or more host computers by said intelligent storage controller;
wherein said intelligent storage controller comprises:
means for continuously monitoring data access of a plurality of concatenated storage devices by one or more host data processing systems;
means for receiving an input/output request from one of the host data processing systems for data access to the plurality of concatenated storage devices;
means for determining whether the input/output request is a request to write new data, a request read stored data or a request to update stored data;
means, responsive to determining that the input/output request is a request to write new data, for:
writing a primary data copy to a first concatenated storage device, wherein said first concatenated storage device has the lowest utilization of the plurality of concatenated storage devices;
writing a secondary data copy to a second concatenated storage device, wherein said second concatenated storage device has the lowest utilization of the plurality of concatenated storage devices excluding the first concatenated storage device;
means, responsive to determining that the input/output request is a request to read stored data, for:
determining which of either the primary data copy or the secondary data copy is stored in a concatenated storage device having a lower data access than the other concatenated storage device at the time of the read request;
in response to determining that the primary data copy is stored in the concatenated storage device having the lower data access at the time of the read request, reading the primary data copy;
in response to determining that the secondary data copy is stored in the concatenated storage device having the lower data access at the time of the read request, reading the secondary data copy;
means, responsive to determining that the input/output request is a request to update stored data, for:
determining whether either the primary data copy or the secondary data copy is stored in a concatenated storage device having a current data access that exceeds a predetermined threshold;
in response to determining that either the primary data copy or the secondary data copy is stored in a concatenated storage device having a current data access that exceeds a predetermined threshold:
writing a new primary data copy to a first concatenated storage device, wherein said first concatenated storage device has the lowest utilization of the plurality of concatenated storage devices;
writing a new secondary data copy to a second concatenated storage device, wherein said second concatenated storage device has the lowest utilization of the plurality of concatenated storage devices excluding the first concatenated storage device;
in response to determining that neither the primary data copy nor the secondary data copy is stored in a concatenated storage device having a current data access that exceeds a predetermined threshold:
determining which of either the primary data copy or the secondary data copy is stored in a concatenated storage device having a lower data access at the time of the update request;
in response to determining that the primary copy is stored in the concatenated storage device having the lower data access at the time of the read request, updating the primary data copy then subsequently updating the secondary data copy;
in response to determining that the secondary data copy is stored in the concatenated storage device having the lower data access at the time of the read request:
updating the secondary data copy;
setting the secondary data copy as the new primary data copy;
setting the primary data copy as the new secondary data copy; and
subsequently updating the new secondary data copy.

6. The system of claim 5, wherein said intelligent storage controller further comprises:
means for continuously monitoring an error rate for each of the plurality of concatenated storage devices; and
means, responsive the error rate of one of the plurality of concatenated storage device exceeding a predetermined threshold, for moving data from the concatenated storage device having the error rate that exceeds the predetermined threshold to a concatenated storage device that does not have an error rate that exceeds the predetermined threshold.

7. The system of claim 5, further comprising:
means for continuously monitoring a storage capacity of each of a plurality of concatenated storage devices;
means for determining whether one of the plurality of concatenated storage devices has reached a maximum storage capacity; and
means, responsive to determining that one of the plurality of concatenated storage devices has reached a maximum storage capacity, for selectively reducing the power consumption of the concatenated storage device that has reached the maximum storage capacity.

8. The system of claim 5, further comprising:
means for determining whether one of the plurality of concatenated storage devices has exceeded a predetermined threshold of time since the most recent input/output request; and
means, responsive to determining that one of the plurality of concatenated storage devices has exceeded a predetermined threshold of time since the most recent input/output request, for selectively reducing the power consumption of the concatenated storage device that has exceeded a predetermined threshold of time since the most recent input/output request.

9. A computer-readable medium encoded with a computer-executable instructions for efficiently multiplexing a plurality of concatenated storage devices comprising that, when executed cause control circuitry to perform the steps of:
continuously monitoring data access of a plurality of concatenated storage devices by one or more host data processing systems;
receiving an input/output request from one of the host data processing systems for data access to the plurality of concatenated storage devices;
determining whether the input/output request is a request to write new data, a request read stored data or a request to update stored data;
in response to determining that the input/output request is a request to write new data:
writing a primary data copy to a first concatenated storage device, wherein said first concatenated storage device has the lowest utilization of the plurality of concatenated storage devices;
writing a secondary data copy to a second concatenated storage device, wherein said second concatenated storage device has the lowest utilization of the plurality of concatenated storage devices excluding the first concatenated storage device;
in response to determining that the input/output request is a request to read stored data:
determining which of either the primary data copy or the secondary data copy is stored in a concatenated storage device having a lower data access than the other concatenated storage device at the time of the read request;
in response to determining that the primary data copy is stored in the concatenated storage device having the lower data access at the time of the read request, reading the primary data copy;
in response to determining that the secondary data copy is stored in the concatenated storage device having the lower data access at the time of the read request, reading the secondary data copy;
in response to determining that the input/output request is a request to update stored data:
determining whether either the primary data copy or the secondary data copy is stored in a concatenated storage device having a current data access that exceeds a predetermined threshold;
in response to determining that either the primary data copy or the secondary data copy is stored in a concatenated storage device having a current data access that exceeds a predetermined threshold:
writing a new primary data copy to a first concatenated storage device, wherein said first concatenated storage device has the lowest utilization of the plurality of concatenated storage devices;
writing a new secondary data copy to a second concatenated storage device, wherein said second concatenated storage device has the lowest utilization of the plurality of concatenated storage devices excluding the first concatenated storage device;
in response to determining that neither the primary data copy nor the secondary data copy is stored in a concatenated storage device having a current data access that exceeds a predetermined threshold:
determining which of either the primary data copy or the secondary data copy is stored in a concatenated storage device having a lower data access at the time of the update request;
in response to determining that the primary copy is stored in the concatenated storage device having the lower data access at the time of the read request, updating the primary data copy then subsequently updating the secondary data copy;
in response to determining that the secondary data copy is stored in the concatenated storage device having the lower data access at the time of the read request:
updating the secondary data copy;
setting the secondary data copy as the new primary data copy;
setting the primary data copy as the new secondary data copy; and
subsequently updating the new secondary data copy.

10. The computer-readable medium of claim 9, further comprising computer-executable instructions for:
continuously monitoring an error rate for each of the plurality of concatenated storage devices; and
in response to the error rate of one of the plurality of concatenated storage device exceeds a predetermined threshold, moving data from the concatenated storage device having the error rate that exceeds the predetermined threshold to a concatenated storage device that does not have an error rate that exceeds the predetermined threshold.

11. The computer-readable medium of claim 9, further comprising computer-executable instructions for:
continuously monitoring a storage capacity of each of a plurality of concatenated storage devices;
determining whether one of the plurality of concatenated storage devices has reached a maximum storage capacity; and
in response to determining that one of the plurality of concatenated storage devices has reached a maximum storage capacity, selectively reducing the power consumption of the concatenated storage device that has reached the maximum storage capacity.

12. The computer-readable medium of claim 9, further comprising computer-executable instructions for:
determining whether one of the plurality of concatenated storage devices has exceeded a predetermined threshold of time since the most recent input/output request; and
in response to determining that one of the plurality of concatenated storage devices has exceeded a predetermined threshold of time since the most recent input/output request, selectively reducing the power consumption of the concatenated storage device that has exceeded a predetermined threshold of time since the most recent input/output request.
